(19) United States
(12) Patent Application Publication
(10) Pub. No.: US 2016/0061129 A1
(43) Pub. Date: Mar. 3, 2016

(54) SYSTEM AND METHOD OF RECOVERING OXIDATION CATALYST PERFORMANCE

(71) Applicant: Cummins Inc., Columbus, IN (US)

(72) Inventors: Timothy P. Lutz, Columbus, IN (US); Axel Otto zur Loye, Columbus, IN (US)

(21) Appl. No.: 14/473,412

(22) Filed: Aug. 29, 2014

(51) Int. Cl. F02D 41/02; F01N 9/00

(52) U.S. Cl. CPC F02D 41/028; F01N 9/002; F02D 41/027

(57) ABSTRACT

A system and method are disclosed for regenerating an oxidation catalyst used in an aftertreatment system of a multifuel internal combustion engine. According to at least one aspect of the present disclosure, recirculated exhaust gas is employed to enable recovery periods in which the engine generates oxygen-depleted exhaust to desulfate and deoxidize the oxidation catalyst. In certain embodiments, the system may include an exhaust gas recirculation system with a cooler and regulation valve to introduce exhaust gas into the engine.

### TECHNICAL FIELD

The present disclosure generally relates to aftertreatment systems for internal combustion engines, particularly diesel oxidation catalysts for multifuel engines.

### BACKGROUND

A multifuel engine is any type of engine that is designed to burn multiple types of fuels at different times of operation. Multifuel engines may be distinguished from flexible fuel or flex-fuel engines in which different fuels are blended together, and both fuels are stored in the same tank. In contrast, a multifuel engine is configured to operate on one fuel at a time, but that fuel type may be changed. Accordingly, multifuel engines generally have a compression ratio that permits firing the highest octane fuel of the various alternative fuels for which the engine is designed. In certain applications, multifuel engines may have switch settings that are set manually to convert from one fuel type to another. One common application for multifuel engines is in military settings, where the normally-used diesel or gas turbine fuel might not always be available during combat operations for vehicles or power generation units. Another common application may be petroleum well drilling and extraction operations where there may be a readily available supply of natural gas or other alternative to diesel fuel.

In certain applications, multifuel engines must meet stringent emission standards that include limits on the amount of soot, nitrogen oxides (hereafter “NOₓ” to include nitric oxide (NO) and nitrogen dioxide (NO₂)), carbon monoxide (CO), partial or unburned hydrocarbons components of the fuel (“HCs”) and other pollutants that may be emitted. Accordingly, multifuel engines may use aftertreatment systems to reduce engine-out emissions (i.e., exhaust gases emitted by the engine) to allowable regulatory levels before release to the atmosphere, particularly lean-burn engine systems such as diesel engines. Such aftertreatment systems may include one or more of a diesel oxidation catalyst (“DOC”), three-way catalyst, lean NOₓ catalyst, selective catalytic reduction (“SCR”) catalyst, a filtration component, either catalyzed or uncatalyzed (e.g., a diesel particulate filter (“DPF”)), and a cleanup catalyst (e.g., an ammonia oxidation catalyst). However, aftertreatment systems such as DOC are susceptible to catalyst poisoning, which may occur when the DOC is exposed to exhaust gases that include compounds that bind to and, consequently, deactivate the catalyst, preventing the catalyst from effectively treating the exhaust gases. Accordingly, there remains a need for further contributions in this area of technology.

### SUMMARY

A system and method are disclosed for regenerating an oxidation catalyst used in an aftertreatment system of a multifuel internal combustion engine. According to at least one aspect of the present disclosure, recirculated exhaust gas is employed to enable recovery periods in which the engine generates oxygen-depleted exhaust to desulfate and deoxidize the oxidation catalyst. In certain embodiments, the system may include an exhaust gas recirculation system with a cooler and regulation valve to introduce exhaust gas into the engine. This summary is provided to introduce a selection of concepts that are further described herein in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like reference numerals refer to like parts throughout the several views, and wherein:

FIG. 1 is a schematic block diagram of an embodiment of an engine system according to the present disclosure; and

FIG. 2 is a schematic flow diagram of a method for regenerating an oxidation catalyst for an engine system according to the present disclosure.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

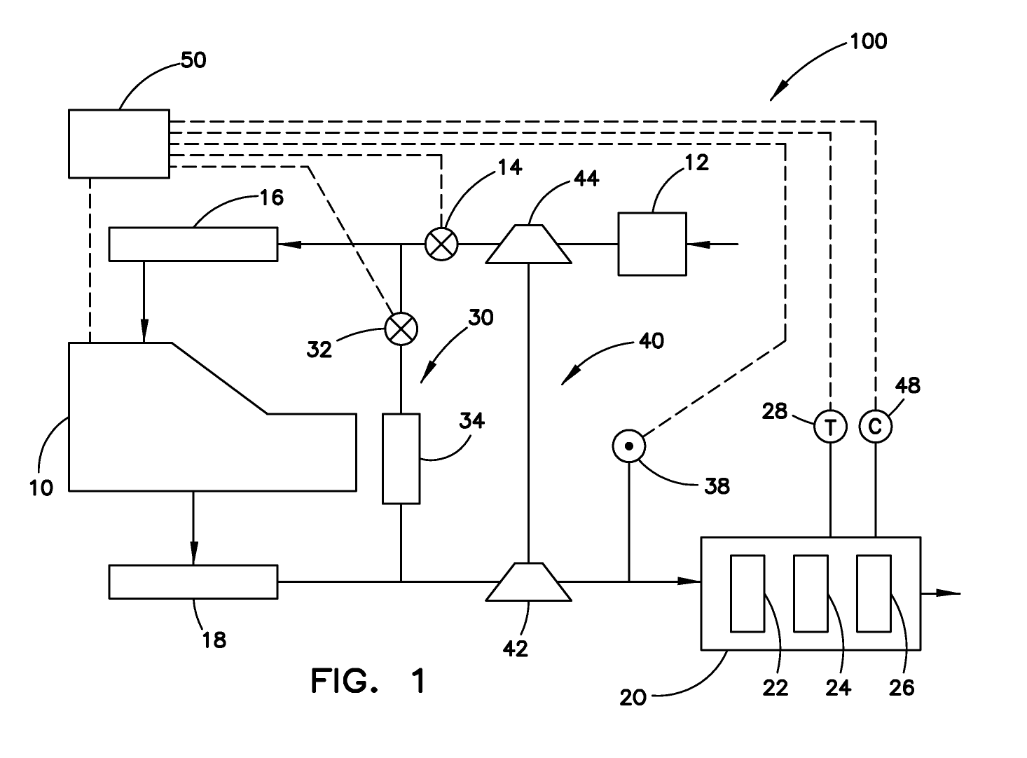

According to at least one embodiment of the present the disclosure as shown in FIG. 1, an engine system 100 may include an engine 10 including an air intake 12 upstream of an intake manifold 16, which enable a flow of atmospheric air into the engine 10 for the combustion of a fuel to generate power. The engine system 100 may further include a throttle 14 disposed upstream of the intake manifold 16 to regulate the flow of air into the engine 10. The throttle 14 may be commanded by a controller 50 as described further herein. The engine 10 may have one or more combustion cylinders and pistons (not shown) to generate mechanical power from the combustion of the fuel. The engine 10 may be an internal combustion engine, including but not limited to a spark-ignition engine or a compression-ignition engine. The engine 10 may be a multifuel engine structured to combust two or more different types of fuels. For example, in certain embodiments, the engine 10 may be structured to enable efficient operation using various fuels. For example, the engine 10 may be configured to operate using either diesel fuel or gasoline, or either diesel fuel or natural gas (i.e., methane). In certain embodiments, the engine 10 may be configured to operate using either diesel fuel or jet fuel, including but not limited to Jet A, Jet A-1, and JP-8. In at least one embodiment, the engine 10 may be capable of operating on more than two types of fuel, including but not limited to alcohol, synthetic fuels, blends, and lubricating oil. Further, the engine 10 may be structured to operate on any suitable combination of fuel.

In certain embodiments, the engine 10 may operate on straight diesel fuel or a combination of diesel fuel and natural gas. In such an embodiment, for a given cycle of the engine 10 natural gas may be introduced into the cylinders of the engine 10 via the intake manifold 16, similar to a conventional spark-ignition engine (i.e., port injection). Near the end of a compression stroke of the engine 10, diesel fuel may be injected into the cylinder by a fuel injector, in addition to the natural gas previously introduced by port injection, and ignited like a conventional compression-ignition engine. Combustion of the diesel fuel causes the natural gas to burn. In at least one embodiment, the engine 10 may operate solely on diesel fuel under certain operating conditions (e.g., start-up and/or transient power demands) or on a substitution mixture of diesel and natural gas of about 50-70% natural gas for diesel fuel. Such an embodiment of a multifuel engine 10 may be suitable for, but not limited to, such applications as power generation for well drilling and servicing, where natural gas is available on site. In certain embodiments, the substitution rate of a second for a first fuel may be as much as 100%.

Regardless of the types of fuel combusted in the engine 10, a total quantity of fuel supplied is mixed with air from the intake manifold 16 according to a predetermined air/fuel ratio. In a conventional multifuel engine at least partially using diesel fuel, the air/fuel ratio is generally a lean mixture, meaning the mixture includes more air (i.e., oxygen) than needed to combust the amount of fuel introduced into the engine. An air/fuel ratio having only enough air to combust the available fuel is commonly called a stoichiometric mixture. Further, an air/fuel ratio having less air than needed to completely burn all the available fuel is commonly called a rich mixture. The engine system 100 may be operated on mixtures that are lean, stoichiometric, and rich depending on the operating mode of the engine 10 as described further herein.

The engine system 100 may include an exhaust manifold 18 in fluid communication with the engine 10 to route a flow of exhaust gas out of the engine 10. The exhaust gas is generated by the combustion of the fuel in the engine 10 and may include combustion products such as carbon dioxide and water vapor. The engine system 100 may further include an aftertreatment system 20 in fluid communication with the engine 10 via the exhaust manifold 18 and structured to remove prescribed pollutants from the flow of exhaust gas. The aftertreatment system 20 may include one or more catalytic and/or filtration components known in the art. For example, conventional multifuel engines emit a relatively high quantity of HCs, often necessitating the use of an oxidation catalyst to reduce the HCs to allowable regulatory levels. In at least one embodiment, the aftertreatment system 20 may include an oxidation catalyst, such as a diesel oxidation catalyst (“DOC”) 22. The aftertreatment system 20 may include a filtration component (either catalyzed or uncatalyzed), such as a diesel particulate filter (“DPF”) 24. The aftertreatment system 20 may further include a NOₓ reduction catalyst 26 (e.g., three-way catalyst, lean NOₓ catalyst, selective catalytic reduction (“SCR”) catalyst, etc.). Example aftertreatment systems 20 may further include a cleanup catalyst (e.g., an ammonia oxidation catalyst). In certain embodiments, the NOₓ reduction catalyst 26 may be a SCR system structured to catalyze NOₓ into diatomic nitrogen, carbon dioxide, and water using diesel exhaust fluid (“DEF”) as a reductant. The DEF may be stored and dispensed from a doser (not shown), having a finite capacity, in communication with the exhaust gas generated from the engine 10.

The DOC 22 may be any suitable catalytic device comprising an oxidation catalyst that can be regenerated by exposure to an oxygen-depleted environment as described further herein. In at least one embodiment, the DOC 22 may be structured to catalyze the oxidization of CO and HCs, such as short chain alkanes, contained in the exhaust gas into innocuous products such as carbon dioxide and water vapor. Commonly found in natural gas, short chain alkanes include methane, propane and ethane, which may be difficult to oxidize in a certain oxidation catalytic devices. Nonetheless, the reactants may include hydrocarbons of all types, such as CO and the soluble organic fraction (SOF) of the diesel particulate matter. The SOF consists of unburned hydrocarbons from fuel and lubricating oil from the engine 10 that have condensed on the solid carbon particles contained in the exhaust gas. The DOC 22 may include a flow-through monolithic honeycomb substrate, either metallic (e.g., aluminum) or ceramic, coated with an oxidizing catalyst, such as a precious metal catalyst. The honeycomb structure of the DOC 22 provides a relatively large surface area of catalyst to facilitate oxidation of the pollutants.

Certain catalysts and catalyst formulations may be more effective at oxidizing particular compounds than others. For example, palladium is a particularly effective oxidizer of short chain alkanes. In certain embodiments and applications, palladium may be more than 80% effective in oxidizing methane. In at least one embodiment, the DOC 22 may include platinum, palladium, iridium, ruthenium, osmium, rhodium (i.e., platinum group metals) and a combination thereof. For example, platinum and palladium may be used together because, though platinum is more catalytically active in certain applications and less prone to contamination, palladium can stabilize platinum particles to maintain the aggregate surface area of the platinum particles by preventing them from sintering together at higher temperatures. Consequently, the DOC 22 may include a single oxidizing catalyst, or combination of oxidizing catalysts, effective at oxidizing CO and HCs, such as short chain alkanes. Further, the choice of catalyst may depend upon the specific regulatory emissions standards applicable for a given application.

The system 100 may further include a turbocharger 40 in communication between the exhaust manifold 18 and the intake manifold 16. The turbocharger 40 may include a turbine 42 in fluid communication with the flow of exhaust gas exiting the exhaust manifold 18. The turbine 42 may be disposed upstream of the aftertreatment system 20 and be structured to convert at least a portion of the energy of the relatively hot and high pressure exhaust gases into a torque. The turbocharger 40 may further include a compressor 44 in fluid communication with the flow of charge gases upstream of the intake manifold 16 and driven by the torque generated by the turbine 42. The compressor 44 may be structured to compress the charge gases and push an increased mass of charge gases through the intake manifold 16 and into the cylinder, thereby increasing the power output of the engine 10 in proportion to the mass of the charge gases pushed into the cylinder. In at least one embodiment, the compressor 44 may be disposed upstream of the intake throttle 14. The turbocharger 40 may include, but not be limited to, a multiple stage turbocharger, a variable geometry turbocharger (VGT), or a turbocharger having a wastegate or bypass valve in certain embodiments. Additionally or alternatively, the system 100 may include a mechanically driven supercharger in communication with the intake manifold 16 and capable of pushing compressed charge gases through the intake manifold 16 and into the engine 10.

The aftertreatment system 20 may further include one or more temperature sensors 28 in communication with the flow of exhaust gas through the aftertreatment system 20. The temperature sensor 28 may be any suitable device, including but not limited to a thermocouple, thermistor, and pyrometer. The temperature sensor 28 may be in communication with the controller 50 to provide feedback on the performance of the aftertreatment system 20. For example, the temperature sensor 28 may provide warning information that the aftertreatment system has exceeded a maximum safe operating temperature. Additionally, the temperature sensor 28 may be combined with another temperature sensor 28 positioned upstream of the catalytic components to determine whether a measured temperature rise across a given catalytic component indicates that the aftertreatment system 20 is operating properly. In at least one embodiment, the aftertreatment system 20 may include two temperature sensors 28, one positioned immediately upstream of the DOC 22 and another positioned immediately downstream of the DOC 22 such that a temperature change across the DOC 22 may be determined by the controller 50.

The aftertreatment system 20 may further include one or more oxygen sensors 38 in communication with the flow of exhaust gas and the controller 50 to monitor oxygen levels. The oxygen sensor 38 may be disposed between the exhaust manifold 18 and the aftertreatment system 20 to determine the amount of free oxygen in the exhaust gas entering the aftertreatment system 20 as part of a closed-loop control structure. In at least one embodiment, the aftertreatment system 20 may include another oxygen sensor 38 in communication within the aftertreatment system 20 to provide feedback to the controller 50 on the performance of the same. In one example, the oxygen sensor 38 may determine the concentration of oxygen in the exhaust gases as a proxy for the concentration of regulated emissions or as described further herein. In a further example, the oxygen sensor 38 may determine the concentration of oxygen in the exhaust gases as part of a feedback control structure to confirm the air/fuel mixture is sufficiently rich to yield little or no oxygen in the exhaust gas. In at least one embodiment, the oxygen sensor 38 may a switching sensor commonly used on spark-ignition engines.

The aftertreatment system 20 may further include one or more chemical sensors 48 in communication with the flow of exhaust gas and the controller 50 to monitor the concentration of certain chemical species. The chemical sensor 48 may be any suitable analytical device that can provide information about the chemical composition of the exhaust gas in the form of a physical signal that is correlated with the concentration of the target chemical species. For example, the chemical sensor 48 may be structured to determine the concentration of short chain alkanes, such as methane, in the exhaust gas. In such an embodiment, the chemical sensor 48 may be disposed downstream of the DOC 22 to indicate whether the DOC 22 is effectively oxidizing such short chain alkanes.

A catalytic device, such as the DOC 22, may lose its catalytic capability over time due to various deactivation mechanisms, including fouling, poisoning, and sintering. Fouling generally refers to the formation of carbonaceous residues that cover the active sites of the catalyst, which decreases its active surface area, thus decreasing its effectiveness. Sintering generally refers to the agglomeration of the active catalytic species (i.e., the precious metal) under certain operating conditions such as high temperature and high humidity environments. Sintering decreases the effectiveness of the catalyst as active particles migrate and stick together on a crystalline or atomic level, thus reducing the active surface area of the catalytic device.

Catalyst poisoning may occur when a catalytic device, such as the DOC 22, is exposed to exhaust gas containing compounds that interact with and/or bind to the active catalytic surfaces of the device, occupying the active catalytic sites and thereby preventing contact with and treatment of the exhaust gas. Another type of catalyst poisoning may be the formation of oxides of the active catalytic species used in the catalytic device, generally referred to as precious metal oxides. The formation of precious metal oxides may be more likely in high temperature, oxygen-rich conditions such as the exhaust gas from a lean-burn engine, where the exhaust gas includes ample quantities of free oxygen at elevated temperatures. Consequently, contaminating compounds may poison and gradually deactivate an oxidation catalyst, and certain types of catalysts may be susceptible to poisoning by certain contaminants. Further, in the case of a multifuel engine operating on diesel fuel, the cooler, lean-mixture environments produced by conventional diesel fuel combustion processes may be particularly susceptible to deactivation by sulfur poisoning, and spontaneous desorption rarely occurs. Moreover, besides the temperature differences, lean mixtures, which include excess oxygen, tend to produce a highly oxidizing environment relative to stoichiometric or rich mixtures, thus yielding more precious metal oxides, such as sulfur oxides, that may poison the oxidation catalyst.

Common catalyst contaminants may include lead, magnesium, silicone, sulfur, and organic compounds of the same. Referring specifically to sulfur poisoning, for example, though palladium is a particularly effective oxidizer of short chain alkanes, palladium is relatively easily poisoned by sulfur by both the deposition of sulfur compounds on the catalytic surface and the formation of palladium oxides (e.g., SO2, SO3, and/or SO4). Without being held to a specific theory, in the case of a catalytic device containing a palladium catalyst, it is thought that deactivation of a palladium-based catalyst is caused by adsorption of sulfur compounds, such as sulfur oxides, onto the palladium particles with eventual spillover of sulfur onto the substrate structure. At relatively low temperatures (i.e., around 240° C.), the adsorption rate of sulfur oxides on the palladium particle and into the substrate may be maximized and thus the deactivation is very rapid. At higher temperatures (i.e., more than about 500° C.), the sulfur oxide adsorption rate on the palladium particles is substantially lower, and any sulfur oxides adsorbed into the substrate begin to desorb resulting in at least partial regeneration of the catalyst. However, raising the exhaust temperature above approximately 800° C. may damage the catalytic device such that performance cannot be recovered. Thus, the catalytic performance of such a catalytic device may gradually worsen over time due to poisoning but may be at least partially restored by regenerating the device periodically.

Accordingly, one means of regenerating an oxidation catalyst is a controlled increase in the temperature of the exhaust gas while further depleting the exhaust gas of free oxygen. One means of producing exhaust gas at an elevated temperature and no free oxygen is to burn additional fuel in the exhaust gas outside of the engine but upstream of the catalytic device to consume any free oxygen and raise the temperature. Alternatively, burning a stoichiometric or rich air/fuel mixture in the engine will increase the temperature of the exhaust gas relative to a lean mixture and deplete oxygen. Accordingly, under the higher temperature, near or above stoichiometric operating conditions, desulfation may occur spontaneously as sulfur oxides formed on the catalyst desorb in the hot, oxygen-poor conditions and much of the catalyst's performance is restored. However, the recited approaches have several drawbacks including increased fuel consumption, soot and CO emissions, and likelihood of knock, which can damage the engine. Moreover, the high temperatures produced by operating the engine near or above stoichiometric for sustained periods may damage both the engine and the aftertreatment system. Further, to oxidize and eliminate unwanted CO from the exhaust gas, the exhaust gas must include some free oxygen on at least a periodic basis.

To effectively regenerate the DOC 22 according to the present disclosure, the air/fuel ratio must be at least stoichiometric, meaning the air/fuel mixture introduced into the engine 10 should comprise only enough, or slightly less, oxygen to consume the available fuel and leave no remaining free oxygen. The air/fuel equivalence ratio, designated lambda, is useful for comparing different air/fuel mixtures. Lambda is the ratio of the actual air/fuel ratio to the stoichiometric air/fuel ratio for a given mixture. Thus, lambda=1.0 for stoichiometric mixtures, for rich mixtures lambda<1.0, and for lean mixtures lambda>1.0. In practice, to ensure that all available free oxygen is actually consumed in the combustion process the necessary air/fuel ratio may be greater than stoichiometric, that is, more rich (i.e., lambda<1.0). As a non-limiting example, the engine 10 may be operated at a rich air-fuel ratio such that lambda is about 0.95. Such an operating condition may ensure that the resulting exhaust gas has no more than approximately 0.5% free oxygen by volume. More generally, to effectively regenerate the DOC 22 according to the present disclosure, the engine 10 may be operated at whatever air/fuel ratio yields exhaust gas having zero or nearly zero free oxygen.

In at least one embodiment according to the present disclosure, the engine system 100 may include an exhaust gas recirculation (“EGR”) system 30. The EGR system 30 may be disposed between the exhaust manifold 18 and the intake manifold 16 and may be structured to recirculate at least a portion of the exhaust gas exiting the engine 10 via the exhaust manifold 18 into the intake manifold 16 and back into the engine 10. Exhaust gas routed back into the engine 10 via the EGR system 30 may be referred to as “EGR gas.” The EGR system 30 may include an EGR valve 32 structured to regulate and synchronize the flow of exhaust gas through the EGR system 30 and into the intake manifold 16. The EGR system 30 may further include an EGR cooler 34 structured to transfer heat from the exhaust gases routed therethrough. The EGR cooler 34 may be any type of suitable heat exchanger and, by cooling the exhaust gases flowing through the EGR system 30, may both increase the mass of the EGR gas routed back into the intake manifold 16 and lower the temperature of combustion within the engine 10. In at least one embodiment, the EGR system 30 may include a bypass line (not shown) to selectively bypass the EGR cooler 34 and route uncooled exhaust gases to the intake manifold 16 as desired. Such an embodiment of the EGR system 30 may be effective under low engine load conditions. In embodiments that include the turbocharger 40 and/or the aftertreatment system 20, the EGR system 30 may be positioned between the exhaust manifold 18 and the intake manifold 16 downstream of the turbine 42 and/or the aftertreatment system 20 and upstream of the compressor 44.

The EGR system 30 enables the engine system 100 to regenerate the DOC 22. Because the EGR gas is comprised primarily of CO2 and water, the EGR gas displaces oxygen-containing air and contributes toward generating oxygen-free exhaust gas. The quantity of EGR gas introduced may be controlled by the controller 50 via the EGR valve 32 or other means such that little or no oxygen remains after combustion of the fuel to be entrained in the exhaust gas. By periodically introducing sufficient quantities of EGR gas into the engine 10 via the EGR system 30, the engine 10 may be periodically operated at a rich air/fuel ratio without generating excessive engine or exhaust gas temperatures. Accordingly, the introduction of EGR gas limits, buffers, and controls the temperature increase associated with operating at a rich air/fuel ratio.

The EGR system 30 enables the engine 10 to be operated at a condition that generates oxygen-depleted exhaust at an elevated, but not excessive, temperature for a period that enables desorption of contaminants from the catalytic surface of the DOC 22 and oxidation of formed catalyst oxides. Such operating conditions may reverse the effects of catalyst poisoning, including sulfur poisoning. Exposing the DOC 22 to a flow of oxygen-depleted exhaust gas causes the sulfur oxides to desorb from the catalytic surfaces. Sulfur oxides desorb from the catalytic surfaces at lower temperatures due to the oxygen-poor conditions created by the use of EGR gas in the combustion process. Further, exposure to oxygen-depleted exhaust gas reduces oxides formed on the catalytic surface. The target exhaust gas temperature for the engine system 100 may depend on the specific catalyst formulation of the DOC 22. In certain embodiments, the target exhaust gas temperature may be between about 350-500° C. In at least one embodiment, the target exhaust gas temperature may be around 600° C.

EGR gas may be introduced into the combustion cylinder of the engine 10 by means other than the EGR system 30. In embodiments that include the turbocharger 40 and in which the turbocharger 40 is a VGT, EGR gas may be introduced into the engine 10 by using the VGT to increase the exhaust manifold pressure until it exceeds the inlet manifold pressure, which enables the recirculation of exhaust gas from the exhaust manifold 18 into the engine 10. Additionally and/or alternatively, EGR gas may be introduced via a turbocharger wastegate or bypass valve in certain embodiments. Alternatively, in embodiments of the engine 10 that include a variable valve timing (VVT) system, EGR gas may be introduced into the engine 10 by using the VVT system to adjust timing of the valves (not shown) of the engine 10 such that at least a portion of the gas generated during the combustion process remains in the engine 10 and is not enabled to flow from the engine 10 as exhaust gas.

Under certain operating conditions, the DOC 22 may further assist with regeneration of the DPF 24 by raising the temperature of the exhaust gas via the exothermic oxidation reactions catalyzed by the DOC 22 and by oxidizing at least a portion of the NO_{X} to NO2, which oxidizes carbon at a lower temperature than oxygen, thereby facilitating DPF regeneration at a lower exhaust temperature. Moreover, introducing EGR gas, which has a lower fraction of oxygen, into the engine 10 lowers the temperature of the combustion process, which may reduce the amount of certain emissions generated during combustion such as NOₓ. Also, EGR gas, being comprised of mostly carbon dioxide and water vapor, has a higher specific heat than the ambient air introduced into the engine 10, thereby further lowering peak combustion temperatures and emissions formation.

As will be appreciated by the description that follows, the operations described herein to regenerate an oxidation catalyst may be implemented in the controller 50, which may include one or more modules for controlling different aspects of the system 100. In one form the controller 50 is an engine controller. The controller 50 may be comprised of digital circuitry, analog circuitry, or a hybrid combination of both of these types. Also, the controller 50 may be programmable, an integrated state machine, or a hybrid combination thereof. The controller 50 may include one or more Arithmetic Logic Units (ALUs), Central Processing Units (CPUs), memories, limiters, conditioners, filters, format converters, or the like which are not shown to preserve clarity. In one form, the controller 50 is of a programmable variety that executes algorithms and processes data in accordance with operating logic that is defined by programming instructions (such as software or firmware). Alternatively or additionally, operating logic for the controller 50 may be at least partially defined by hardwired logic or other hardware.

The controller 50 may be exclusively dedicated to monitoring and maintaining the performance of the DOC 22. The controller 50 may be further structured to control other parameters of the engine 10, which may include aspects of the engine 10 that may be controlled with an actuator activated by the controller 50. Specifically, the controller 50 may be in communication with actuators and sensors for receiving and processing sensor input and transmitting actuator output signals. Actuators may include, but not be limited to, the throttle 14 and the EGR valve 32. The sensors may include any suitable devices to monitor parameters and functions of the engine system 100, such as the temperature sensor 28, the oxygen sensor 38, and the chemical sensor 48.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 100. As used herein, the term “sensors” may include any suitable hardware and/or software used to sense any engine system parameter and/or various combinations of such parameters either directly or indirectly.

In certain embodiments, the controller 50 may include one or more modules structured to functionally execute the operations of the controller 50. The description herein including modules emphasizes the structural independence of the aspects of the controller 50, and illustrates one grouping of operations and responsibilities of the controller 50. Other groupings that execute similar overall operations are understood within the scope of the present application. Modules may be implemented in hardware and/or software on a non-transient computer readable storage medium, and modules may be distributed across various hardware or software components.

The schematic flow descriptions that follow provide illustrative embodiments of performing operations for regenerating an oxidation catalyst. Operations illustrated are understood to be exemplary only, and operations may be combined or divided, and added or removed, as well as re-ordered in whole or part, unless stated explicitly to the contrary herein. Certain operations illustrated may be implemented by a computer executing a computer program product on a non-transient computer readable storage medium, where the computer program product comprises instructions causing the computer to execute one or more of the operations, or to issue commands to other devices to execute one or more of the operations.

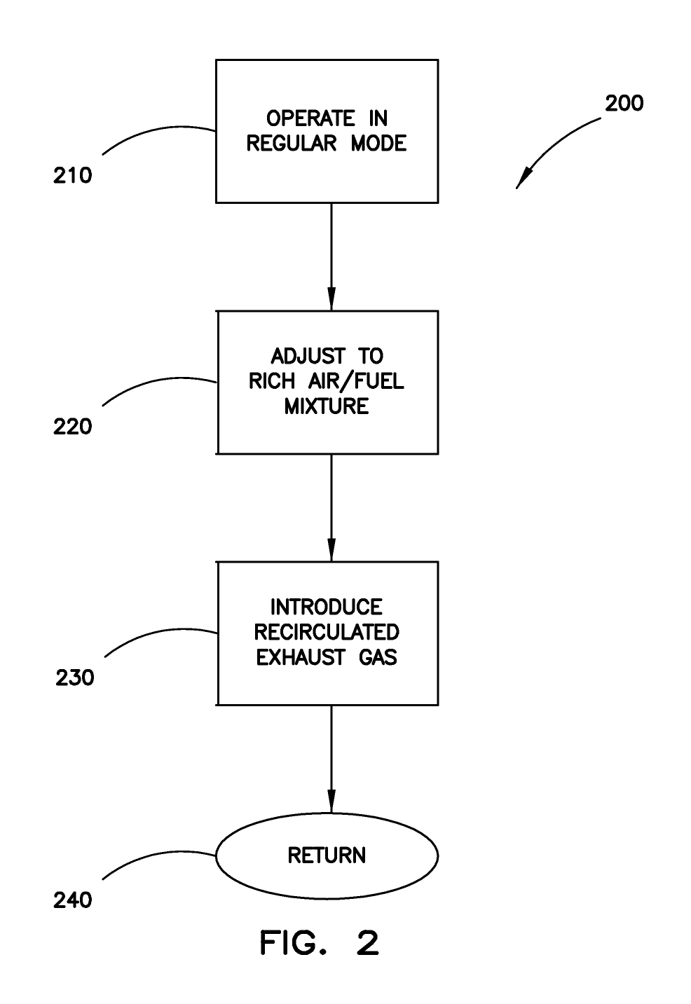

As shown in FIG. 2, a method of regenerating an oxidation catalyst according to the present disclosure, such as the DOC 22, may include an operation to periodically adjust the operating condition of the engine 10 from a regular operating mode into a regeneration mode on a prescribed basis. The regular operating mode may include any suitable set of operating parameters sufficient to meet the desired power output, fuel consumption, and emissions levels of the engine system 100. In certain embodiments, the regular operating mode may include a lean air/fuel ratio. The regeneration mode may include operating at a near-stoichiometric or rich air/fuel ratio such that the exhaust gas has little or no free oxygen. The regeneration mode may further include introducing EGR gas into the rich air/fuel mixture. The method may further include an operation of returning the engine 10 to the regular operating mode after a prescribed period. Accordingly, a method 200 of regenerating an oxidation catalyst according to the present disclosure, such as the DOC 22, may include an operation 210 of initially operating the engine 10 in a regular operating mode. The method 200 may include periodically adjusting the operating condition of the engine 10 from the regular operating mode into a regeneration mode on a prescribed basis. Adjusting the operating condition to the regeneration mode may include an operation 220 of adjusting the air/fuel ratio to a rich mixture and an operation 230 of introducing recirculated exhaust gas into the rich air/fuel mixture. The method may further include an operation 240 of returning the engine 10 to the regular operating mode after a prescribed period.

The prescribed period may be the period of time sufficient to substantially desulfate and/or deoxidize the DOC 22. The prescribed basis may be any parameter related to the degree of sulfur poisoning of the DOC 22. In certain embodiments, the prescribed basis may be a timer configured to determine the amount of time the engine has been operating in the regular operating mode relative to a predetermined threshold time. The predetermined threshold time may depend on the characteristics of the engine 10 such as, for example, its thermal capacitance. In at least one embodiment, as a non-limiting example, the prescribed basis may be about every 10 minutes, and the predetermined threshold time may be about 30 seconds. Alternatively, the prescribed basis may be about every 2 hours, and the predetermined threshold time may be about 5 minutes. As the forgoing examples suggest, the prescribed basis and predetermined threshold time may be selected to ensure the DOC 22 is substantially desulfated and/or deoxidized.

In certain embodiments, the prescribed basis may be an estimate of the degree of sulfation or poisoning of the oxidation catalyst, and such an estimate may be based on the duty cycle of the engine 10 since the most recent prescribed period. In such an embodiment, the controller 50 may monitor duty cycle of the engine 10 and record the durations at which the engine 10 operates under the conditions of the duty cycle to thereby estimate the degree of sulfation or poisoning. The duty cycle may include torque demand, engine speed, quantity and type of fuel consumed, and operating time, among other operating parameters.

In alternative embodiments, the prescribed basis may be a sensed parameter from at least one sensor indicating that the performance of the oxidation catalyst has degraded below a threshold level. The sensed parameter may be any suitable detectable parameter of the engine system 100 that is indicative of the performance of the DOC 22 as affected by contamination, sulfation, and/or poisoning. In certain embodiments, the sensed parameter may be a temperature rise across the oxidation catalyst relative to a threshold value. When functioning properly, the DOC 22 may raise the temperature of the exhaust gas passing therethrough because the oxidation reactions occurring within the DOC 22 are exothermic. The heat energy released by the oxidation of CO and HCs will generally increases the temperature of the exhaust gas. Moreover, poisoning of the DOC 22 reduces its catalytic capacity such that less exhaust gas may be oxidized, which in turn generates less heat energy and lowers the resulting temperature rise of the exhaust gas flowing through the DOC 22. Accordingly, the temperature rise across the DOC 22 may decrease over time as the DOC 22 becomes poisoned. Thus, the temperature rise across the DOC 22, as determined by the one or more temperature sensors 28, may be indicative of the performance of the DOC 22 and may be exploited to initiate the regeneration mode.

In certain embodiments, the sensed parameter may be the presence of HCs in the exhaust gas downstream of the oxidation catalyst exceeding a threshold value. In such embodiments, the chemical sensor 48 may be used to determine whether an increasing concentration of HCs are passing through the DOC 22 untreated (i.e., not oxidized). Such an increase may be indicative of poisoning of DOC 22, requiring initiation of the regeneration mode.

The operation 230 of introducing EGR gas into the rich air/fuel mixture may be accomplished using the EGR system 30 and may be regulated by the EGR valve 32 commanded by the controller 50. Alternatively, the operation 230 of introducing EGR gas into the rich air/fuel mixture may be accomplished using variable valve timing or a variable geometry turbocharger.

Because the EGR system 30 may be employed only periodically to regenerate the DOC 22, the total heat rejection of the engine system 100 may be less than conventional engine systems that use EGR continually. Heat rejection generally is the process of removing heat from an engine. The majority of the heat is rejected by an engine block and cylinder heads and in a charge air cooler, EGR cooler, oil cooler, and exhaust gas. Typically, a large fraction of the total heat rejected is first transferred to the engine coolant, which carries the heat to the radiators, where it is rejected to the ambient air. In conventional engine systems, the total heat rejected by the radiators increases significantly when cooled EGR is utilized because a significant amount of heat is removed from the exhaust gas as it passes through the EGR cooler. Consequently, in such systems, the radiators, pumps, and other cooling system components may larger, and thus more expensive, than the cooling system components of the engine system 100. Conversely, because the EGR system 30 and EGR cooler 34 of the present disclosure may be employed only periodically, their heat rejection contribution to the engine system 100 is less than a conventional EGR system. Consequently, the cooling system components of the engine system 100, including the radiators (not shown), pumps (not shown), and the EGR cooler 34 may be smaller, have less heat rejection capacity, and cost less than for a conventional engine system.

In alternative embodiments, a means of assessing the performance of the DOC 22 may include operating the engine 10 in an evaluation mode for a period of time and monitoring a change in exhaust gas composition during the period before reverting to the regular operating mode. The evaluation mode may include any suitable operating conditions that enable a determination of the performance of the DOC 22. As a non-limiting example, the evaluation mode may include skipping an ignition cycle in one cylinder of the engine 10 to increase a concentration of unburned fuel (i.e., HCs) in the exhaust gas. The response of the DOC 22 to the increased concentration of HCs may then be monitored to assess its performance. In such an embodiment, the DOC 22 may be monitored by any suitable means including the means disclosed herein. Namely, for example, the temperature rise or concentration of HCs across the DOC 22 may be monitored. Accordingly, use of the evaluation mode to assess the performance of the DOC 22 may enable a well-defined evaluation period to clearly delineate an actual response of the DOC 22 from a desired response, thereby providing a measurable evaluation of the DOC 22.

Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

A variety of embodiments according to the present disclosure are contemplated. Such system embodiments may be employed in a variety of methods, processes, procedures, steps, and operations as a means of controlling a fuel injector for an engine. While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims. Indeed, this disclosure is not intended to be exhaustive or to limit the scope of the disclosure.

Claimed is:

1. A method of regenerating an oxidation catalyst in a multifuel engine, the method comprising:
operating a multifuel engine at a first operating condition, the first operating condition including a lean air-to-fuel mixture, the engine including an oxidation catalyst structured to oxidize compounds in exhaust gas generated by combustion of the lean air-to-fuel mixture in the engine;
periodically adjusting the operating condition of the engine to a second operating condition on a prescribed basis, the second operating condition including a rich or near-stoichiometric air-to-fuel mixture such that the exhaust gas has little or no free oxygen, wherein the second operating condition further includes introducing recirculated exhaust gas into the rich or near-stoichiometric air-to-fuel mixture; and
returning the engine to the first operating condition after a prescribed period.

2. The method of claim 1, wherein the prescribed period is the period sufficient to substantially desulfate and/or deoxidize the oxidation catalyst.

3. The method of claim 1, wherein the prescribed basis is a timer configured to record the amount of time the engine has been operated at the first operating condition relative to a predetermined threshold time.

4. The method of claim 1, wherein the prescribed basis comprises an estimate of the degree of contamination of the oxidation catalyst, the estimate based on a duty cycle of the engine since a previous prescribed period.

5. The method of claim 1, wherein the prescribed basis comprises a sensed parameter from at least one sensor indicating that the performance of the oxidation catalyst has degraded below a threshold level.

6. The method of claim 5, wherein the sensed parameter comprises a temperature rise across the oxidation catalyst relative to a threshold value.

7. The method of claim 5, wherein the sensed parameter comprises a presence of hydrocarbons in the exhaust gas downstream of the oxidation catalyst exceeding a threshold value.

8. The method of claim 1, wherein the recirculated exhaust gas is introduced into the rich or near-stoichiometric air-to-fuel mixture via an exhaust gas recirculation system in communication with the engine, the exhaust gas recirculation system including a valve structured to regulate the quantity of recirculated exhaust gas introduced and an exhaust gas cooler structured to lower a temperature of the recirculated exhaust gas before being introduced into the rich or near-stoichiometric air-to-fuel mixture.

9. The method of claim 1, wherein the recirculated exhaust gas is introduced into the rich or near-stoichiometric air-to-fuel mixture via a variable valve timing system or a variable geometry turbocharger.

10. A method of regenerating an oxidation catalyst in a multifuel engine, the method comprising:
operating a multifuel engine on two or more different fuels, the fuels combined with air to form a mixture having a lean air-to-fuel ratio, wherein the engine comprises an oxidation catalyst structured to oxidize compounds in an exhaust gas generated by combustion of the mixture in the engine;
reducing a quantity of air introduced into the engine to adjust the mixture to at least a stoichiometric air-to-fuel ratio such that the exhaust gas has little or no free oxygen for a prescribed period;
introducing at least a portion of the exhaust gas into the mixture during the prescribed period via an exhaust gas recirculation system;
increasing the quantity of air introduced into the engine to adjust the mixture to the lean air-to-fuel ratio after the prescribed period; and
reducing the portion of the exhaust gas introduced into the mixture after the prescribed period,
wherein the prescribed period comprises a period sufficient to substantially decontaminate the oxidation catalyst.

11. The method of claim 10, wherein the engine further comprises a sensor, the sensor structured to sense a parameter indicating that the performance of the oxidation catalyst has degraded below a threshold level.

12. The method of claim 11, wherein the sensed parameter comprises a temperature rise across the oxidation catalyst relative to a first threshold value or a presence of hydrocarbons in the exhaust gas downstream of the oxidation catalyst exceeding a second threshold value.

13. A system comprising:
a multifuel internal combustion engine structured to combust two or more types of fuel at a prescribed air-to-fuel ratio and generate exhaust gas thereby,
an oxidation catalyst structured to oxidize prescribed compounds in the exhaust gas;
an exhaust gas recirculation system including a valve and structured to recirculate at least a portion of the exhaust gas back into the engine as regulated by the valve; and
a controller in communication with the engine and the valve, the controller structured to operate upon a prescribed condition to periodically adjust the air-to-fuel ratio to a rich or near-stoichiometric air-to-fuel ratio and to increase the portion of the exhaust gas recirculated into the engine via the valve to generate exhaust gas having little or no free oxygen therein,
wherein the controller is further configured to adjust the air-to-fuel ratio to a lean air-to-fuel ratio and decrease the portion of the exhaust gas recirculated into the engine via the valve other than at the prescribed condition.

14. The system of claim 13, wherein the prescribed condition comprises a predetermined time interval.

15. The system of claim 13, wherein the prescribed condition comprises a time interval based at least in part on the duty cycle of the engine since a previous prescribed condition.

16. The system of claim 13, the system further comprising a sensor, wherein the prescribed condition includes a condition in which the performance of the oxidation catalyst has degraded below a threshold value as indicated by the sensor.

17. The system of claim 13, wherein the sensor is a temperature sensor, and the prescribed condition comprises a temperature rise of the exhaust gas across the oxidation catalyst relative to a threshold temperature rise.

18. The system of claim 13, wherein the sensor is a chemical sensor structured to determine a concentration level of hydrocarbons in the exhaust gas, and the prescribed condition comprises a presence of hydrocarbons in the exhaust gas downstream of the oxidation catalyst exceeding a threshold concentration.

19. The system of claim 13, wherein the oxidation catalyst comprises a platinum group metal type catalyst.

20. The system of claim 13, wherein the oxidation catalyst comprises palladium.
